(19) United States
(12) Patent Application Publication
(10) Pub. No.: US 2005/0166022 A1
(43) Pub. Date: Jul. 28, 2005

(54) Method and apparatus for copying and backup in storage systems

(75) Inventor: Naoki Watanabe, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/767,247

(22) Filed: Jan. 28, 2004

(51) Int. Cl. G06F 12/16

(52) U.S. Cl. 711/162

(57) ABSTRACT

A technique is described for controlling a storage system in which primary storage volumes and replication storage volumes are present. A boundary of a potential failure of the primary storage volumes and the replication storage volumes is determined, and using that boundary, replication storage volumes are assigned to assure that at least some of them are outside the failure boundary.

### BACKGROUND OF THE INVENTION

This invention relates to storage systems, and in particular to storage system management in which failure boundaries are taken into consideration when assigning storage volumes.

Large area storage systems are now well known. In these systems massive amounts of data are capable of being stored and automatically backed up or replicated at remote locations to provide increased data reliability. In such systems, large numbers of hard disk drives and sophisticated error correction and redundancy technology are commonly employed. The systems generally operate under control of local and remote application software. Hitachi, Ltd., the assignee of this application, provides local replication software known as “Shadow Image,” and provides remote replication software known as “True Copy.” Remote copy techniques for implementation of software such as this are described in U.S. Pat. No. 5,978,890; U.S. Pat. No. 6,240,494; U.S. Pat. No. 6,321,292; and U.S. Pat. No. 6,408,370. Other companies, for example the IBM Corporation, also provide large area storage systems with these capabilities.

In such systems when backup storage volumes or replication storage volumes are assigned, they are usually assigned by a controller or server which is controlling the storage system. In commercial systems available now, the assignment of such storage volumes to particular groups for functionality as primary storage systems, backup storage systems or replication storage systems is generally done without regard to the potential modes of failure of the storage system itself. This can result in less than optimal performance should failures impact both the primary storage and the secondary storage in certain circumstances. For example, a resulting failure may make it necessary to recopy a large amount of data to another location, delaying use of the primary functionality of the storage system while the extra backup or replication operation is completed. If a particular disk failure occurs, some logical volumes will be impacted. In a conventional storage system, however, the storage controller will not consider the physical layout when it creates a replication pattern. Thus, the physical failure may not only impact the primary volume, but also the replication volumes. The technology described with respect to this invention provides a technique for avoiding this undesirable circumstance.

### BRIEF SUMMARY OF THE INVENTION

This invention provides a technique for improving the replication and backup operations in storage systems to help minimize the impact of failures on more than small portions of the storage system. In some circumstances when a replication volume is assigned into the same failure boundary as a source volume, for example it is assigned to the same error correction group, a single failure may impact both the original volume and the replication volume. In another situation when daily backups are performed, if the storage volume to which the backup operation is assigned falls within the same failure boundary as the source volume, the replication volume will also be impacted. Generally storage systems such as described in this application are robust enough to allow for re-creation of the data, or recopying of the data, to some other replication or primary volume meaning that data will not be lost. An undesirable result of this operation, however, is that the storage system is occupied with such “overhead” functions, impacting the performance of its primary function.

This invention provides a technique for avoiding this undesirable situation. In particular, according to this invention, in a storage environment, levels of failure boundaries are determined. These failure boundaries are determined by reference to what portion of the storage system will be impacted by a particular failure, for example, susceptibility to an error correction failure, a storage controller failure, a storage volume failure, etc. In a preferred embodiment of this invention those failure boundaries are then collected by management software operating or controlling the overall storage system. This management software may also collect information about the storage environment such as performance and reliability information.

Once the failure boundary or boundaries are determined, replication volumes are assigned to assure that they cross failure boundaries. In this manner the impact of a failure event within a given failure boundary is minimized. One technique for assigning failure boundaries to achieve this is to use the logical address assignment as the basis for the awareness of the failure boundaries. These logical addresses typically correspond to volume numbers, error correction groups, or other structure of the storage system. For example, logical addresses having 0 as a first digit may be assigned to volumes stored within failure boundary A, while those logical addresses having a 1 as a first address digit may be assigned to storage volumes within failure boundary B. This assignment can be performed manually, or by the system administrator who uses a graphical user interface, or some other appropriate interface, to make the replication configuration determination.

In a preferred embodiment of the invention a method of controlling a storage system having primary storage volumes and replication storage volumes includes the steps of determining a boundary of a potential failure of the primary storage volumes and the replication storage volumes and using that determined boundary, assigning the replication storage volumes to assure that at least some of them are outside the failure boundary.

A storage system which implements the invention includes a set of primary storage volumes, a set of replication storage volumes which improve the reliability of the storage system, a memory for storing information regarding at least one boundary of a potential failure of the primary storage volumes and the replication storage volumes, and a controller coupled to the memory for assigning replication storage volumes to assure that at least some of them are outside the failure boundary.

### BRIEF DESCRIPTION OF THE DRAWINGS

FIG. 1 illustrates a typical storage system configuration;

FIG. 2 is a block diagram of a VPM server;

FIG. 3 illustrates a logical view of failure boundaries;

FIG. 4 illustrates a horizontal addressing layout;

FIG. 5 illustrates a vertical addressing layout;

FIG. 6 illustrates failure boundary tables within the VPM server;

FIG. 7 illustrates a table of pair configuration;

FIG. 8 is a flow chart illustrating a manual storage management technique;

FIGS. 9 through 11 illustrate graphical user interfaces performing manual configuration control of the storage system, with each figure illustrating a different embodiment;

FIG. 12 is a diagram illustrating the graphical user interface for a user group;

FIG. 13 is a diagram illustrating the policy for a full backup;

FIG. 14 is a flow chart illustrating a hybrid backup process;

FIG. 15 is a flow chart illustrating a full backup schedule;

FIG. 16 is a diagram illustrating a differential backup;

FIG. 17 is a diagram illustrating a differential backup using vertical storage addressing; and

FIG. 18 is a diagram illustrating a disaster recovery technique.

### DETAILED DESCRIPTION OF THE INVENTION

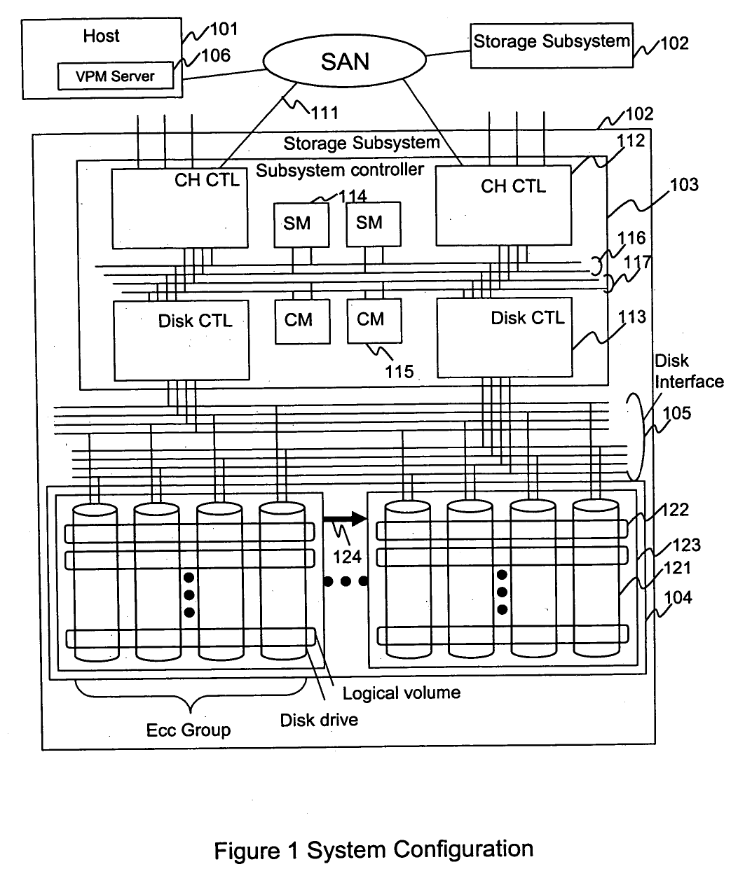

FIG. 1 is a block diagram of a storage system. As shown, host 101 and storage subsystem 102 are connected with an input/output interface 111. Interface 111 can be provided by a fibre channel, ESCON etc. The number of host and storage subsystems 102 is arbitrary. In FIG. 1 a more detailed view of storage subsystem 102 is provided. Subsystem 102 includes a subsystem controller 103 and a disk enclosure 104. The subsystem controller 103 includes channel controllers 112, disk controllers 113, a shared memory 114 and a cache memory 115. These components are usually configured as a pair, i.e. duplicates of each other. Generally each member of the pair belongs to a different power boundary to provide assurance that a single failure of the power supply does not disable both subsystem controllers.

Internal connections 116 and 117 connect the two controllers, the shared memory 114 and the cache memory 115. The shared memory stores control data for the storage system 102. The cache memory stores data from the host 101, typically while writing operations are occurring to transfer that data to the storage volumes. Both the shared memory 114 and the cache memory 115 are preferably backed up with battery power in addition to being connected to separate electrical power sources.

In operation, the channel controller 112 receives an I/O request from the host 101 which it analyzes. Once the analysis is completed, the operation is configured as a job for the disk controller 113. The internal job is stored in the shared memory 114. The disk controller 113 issues I/O requests to the disk drives 121. The disk controller 113 receives the job from the shared memory 114 and issues I/O request to the disk drive 121. The disk enclosure 104 includes the disk drives 121 which are illustrated in a typical physical layout in FIG. 1. Host 101, however, sees only logical volumes, such as logical volume 122. These logical volumes may span many separate hard disk drives or storage volumes. As is known, error correction groups 123 can be provided to enhance reliability. The error correction groups 123 are usually divided among the logical volumes 122. The storage subsystem 102 provides some replication methodology among the logical volumes 122. This replication methodology can include local replication and remote replication. Local replication provides for volume replication within the storage subsystem 102, while remote replication provides logical volume replication across storage systems 102. Both techniques help improve the reliability of the overall storage network.

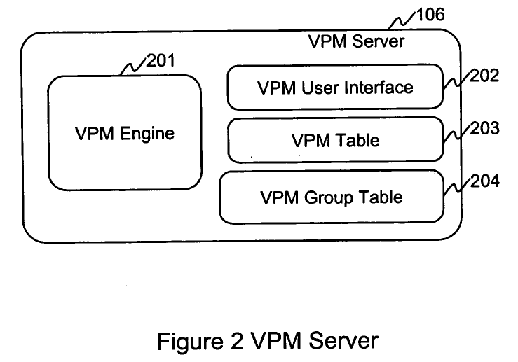

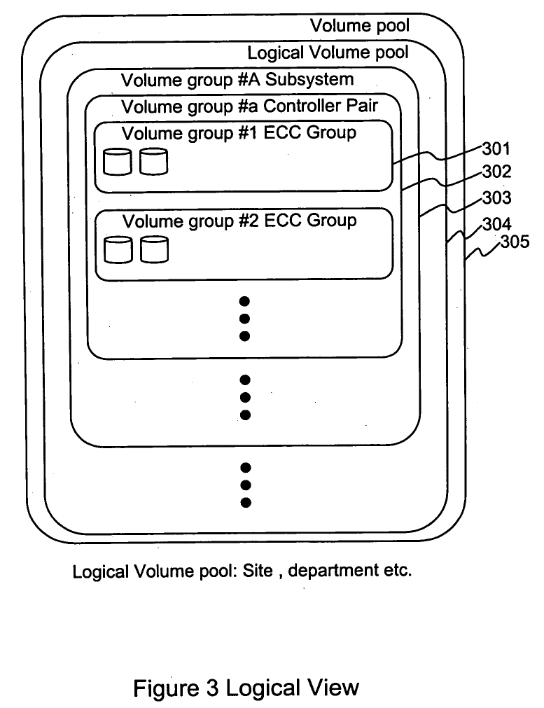

FIG. 2 illustrates one preferred embodiment of a VPM server 106. Server 106 is used in management of the storage system shown in FIG. 1. The server 106 includes a VPM engine 201, a user interface 202 and a table 203. To provide the functionality described in conjunction with this invention, a further table known as a group table 204 is also provided. The group table defines levels of groups of failure boundaries. (Failure boundaries are discussed in conjunction with FIG. 3). In addition to the failure boundaries, the group table may also include information such as reliability information, performance information, statistical information, etc. As will be described, this information enables the VPM server 106 to configure replication pairs based on the type of storage subsystems, the type of logical volumes, the storage space remaining, etc.

FIG. 3 is a diagram illustrating failure boundaries in a typical system. Examples of failure boundaries will make this concept clearer. For example, in FIG. 3 the smallest failure boundary 301 is an error correction group. This small boundary may consist of only one (or a few) disk drives, preferably configured in a RAID type configuration. The failure boundary is used to designate that if one of the disk drives 121 in the ECC group 301 fails, all of the other logical volumes which belong to that group 301 will be impacted. Such a failure will require the data to be reconstructed using the error correction information stored across those shared volumes.

Of course, the concept of a failure boundary can be extended to larger portions of the storage system. For example, all of the error correction groups that happen to be controlled by either one of the controller pair will be impacted if either of the controller pair fail. This failure boundary 302 is also shown in FIG. 3. In a similar manner, any failure of a controller pair within the storage system will affect the subsystem within which that controller pair is situated. This failure boundary is shown as boundary 303. As shown in FIG. 3 this concept can be extended to a pool of logical volumes, and in fact, to the complete pool of all volumes.

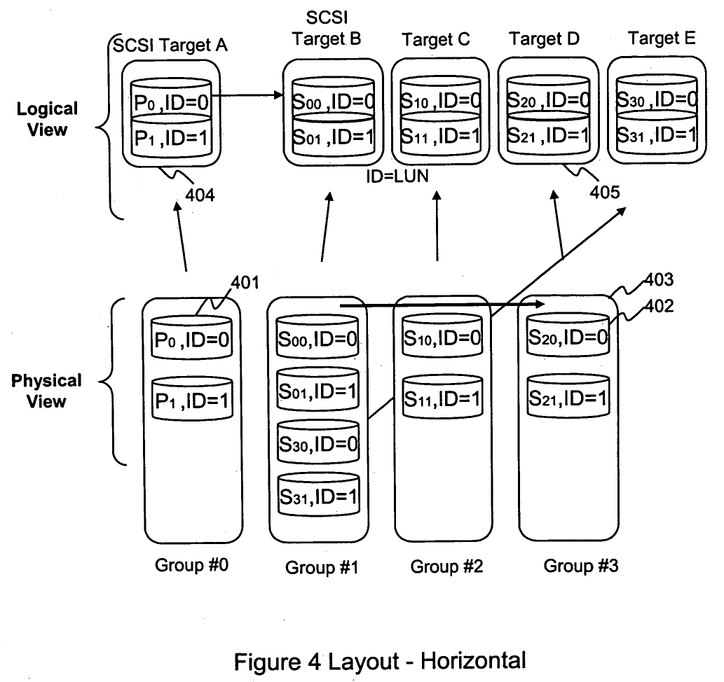

Next will be described two major addressing formats—horizontal and vertical. The addressing format, as will be seen, impacts the manner in which failure boundaries are considered. FIG. 4 illustrates horizontal addressing. As suggested by the name, addresses in horizontal addressing are assigned across the storage volumes. In FIG. 4 the primary volume 401 is located in group #0. In the illustrated case there are three secondary groups 403. This will cause the VPM to locate four secondary volumes 402 out of the three secondary volume groups 403. As mentioned, preferably the groups will cross failure boundaries. The level of the failure boundary will be determined automatically using the system software and an appropriate policy, or the level may be determined by a system administrator. However determined, the level can consist of one error correction group 301, a controller pair 302, etc., as discussed above. Once that assignment is complete, the VPM engine 201 selects a volume from each secondary group 403 and assigns it an identification. The first secondary volume S₀₀ is selected from the first group, the second secondary volume S₁₀ is selected from the next volume group, while the third secondary volume S₂₀ is selected from the next volume group. When the VPM engine 201 needs to select the fourth secondary volume it will return back to the storage volume group 1. In a similar manner primary volume P1 will have secondary volumes as shown in groups 1, 2 and 3 in FIG. 4. In this manner once the VPM engine 201 obtains the physical (internal) allocation, then physical to logical mapping may be completed.

In the implementation depicted in the figures, SCSI is used as an example. In this circumstance the primary has two volumes in one target A, and there are four copies to be made. In such a case the VPM engine 201 makes the four SCSI targets (B, C, D and E) and will have two secondary volumes in each target. In a fibre channel implementation the SCSI will target B, C, D and E and have two secondary volumes in each target. The system management may simply use targets B, C, D and E to obtain reliable replication. In this manner, if group number 2 fails, only the target C drive will be impacted, and other groups and backup copies will not be affected. Of course protocols other than SCSI may be employed.

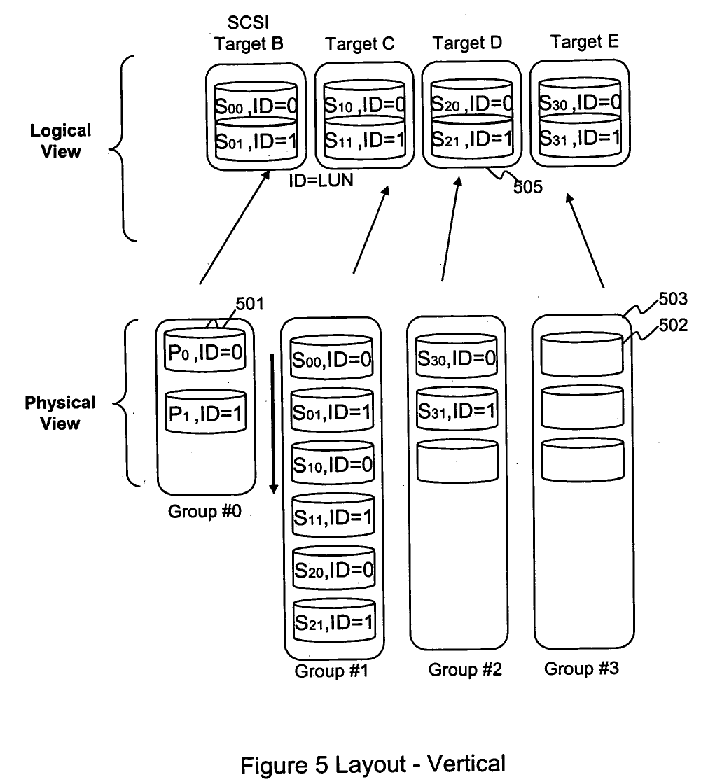

FIG. 5 is a diagram illustrating a vertical addressing layout. In this embodiment the replication volumes are related to each other, for example by being used for incremental backups. As such it is not necessary to use replication volumes across the failure boundary. Thus, in the case of vertical addressing the impact of replication is the same as with example of horizontal addressing; the only differences are the physical arrangement of the storage volumes.

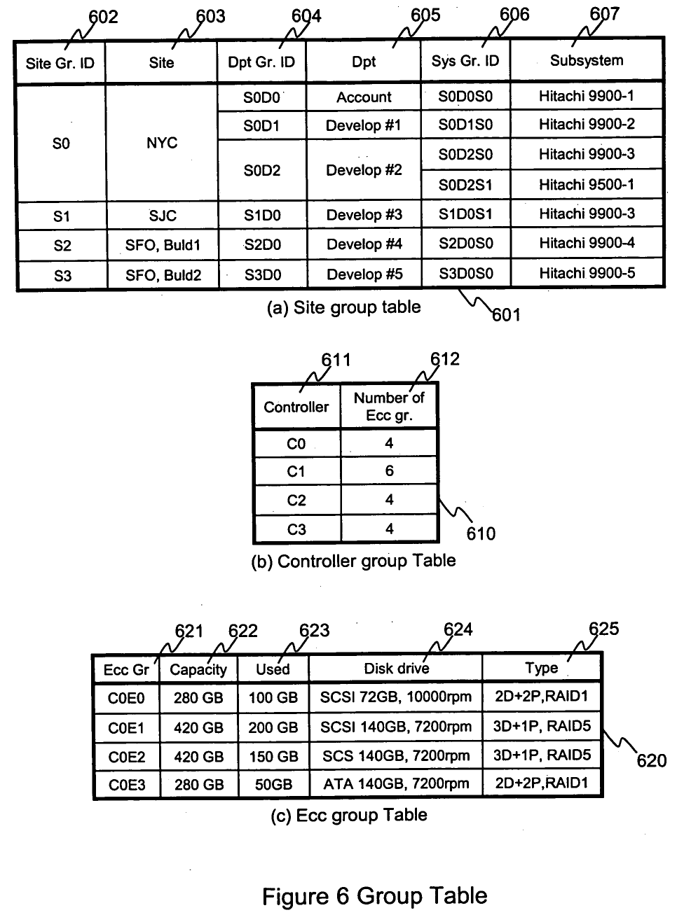

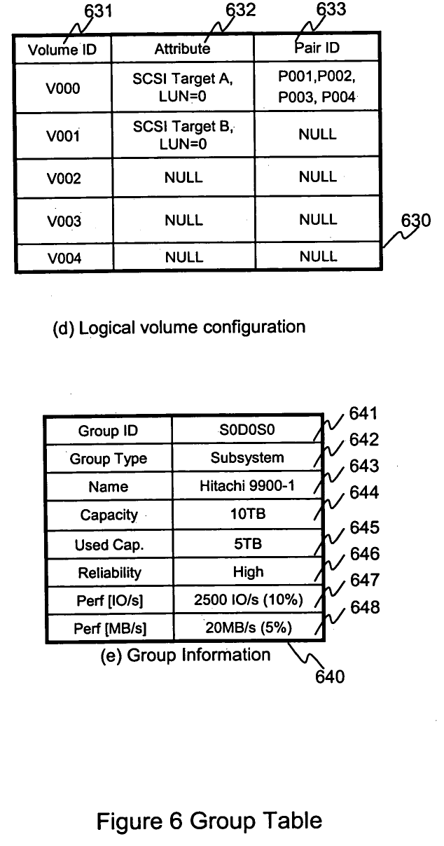

FIG. 6 is a diagram illustrating some of the tables suitable for use in the server to define various failure boundaries. These tables are typically determined by the VPM engine 201 collecting internal information from the storage system 102, for example, such as the controller group table 610 and the error correction group table 620.

The VPM engine 201 creates an overview of the configuration such as the site group table shown in FIG. 6a. The site group table employs three levels of groups—site, department and subsystem. The definition of site and department will depend on the environment in which the storage system is situated. A VPM server 106 for an administrator can define these characteristics. Each site will have a site group ID 602 and a site group name 603. Each department has a department group ID 604 and a department name 605. Each storage subsystem has a subsystem group ID 606 and a subsystem name 607. In the site group table 601 shown in FIG. 6a, the left hand column defines the site group number, with the next column specifying its physical location. The next two columns define a department group ID and a particular department, with the last two columns defining a system group identification and then a subsystem.

The controller group table, shown in the middle of FIG. 6, defines the system in terms of its controllers C0 . . . C3 and specifies the number of error correction groups associated with each controller. The controller group table 610 and the error correction group table are shown in FIG. 6 as separate tables—as would be done in a relational database. Of course these could be merged to make a conventional flat file database.

FIG. 6c depicts an error correction group table, in this example the error correction groups associated with controller C0. As shown in FIG. 6c, controller group C0 includes error correction groups C0E0, C0E1, C0E2 and C0E3. Group E0 is implemented by having a storage capacity of 280 gigabytes (of which 100 gigabytes are presently used). The 280 gigabytes is achieved by using multiple 72 gigabyte SCSI, 10,000 rpm hard disk drives. The type of error correction is shown in the right hand column in FIG. 6c.

The error correction group table includes detailed information on the error correction groups. The name of the group 621, the total capacity of the group 622, the consumed capacity of the group, user 623, the type of disk drives (type 624) and the type of the error correction group 625 are all shown.

FIG. 6d is a table illustrating the logical volume configuration table 630. As shown there, each error correction group includes a logical volume configuration table. The table includes identification of the logical volume ID 631 and a pair ID 633, which provides identification for the pair which can be used to identify replication pairs.

FIG. 6e illustrates a table showing group information. The VPM engine 201 has a capability of making group information such as that shown in Table 6d. Therein the group ID 641 shows the identifier of the group, which may also correspond to the logical volume. The group type can be a subsystem, controller pair 302 or error correction group 301. The Name 643 is the name of the group and the capacity 645 is the total capacity of the group. The used capacity corresponds to the capacity of the group that has been used. The reliability 646 is the reliability of the group. For example, it is now known that RAID1 is more reliable than RAID5. In addition performance statistics, for example I/O per second 647 or megabytes per second 648 may also be maintained. These statistics enable evaluation of random workload (I/O) or sequential workload (MB) information.

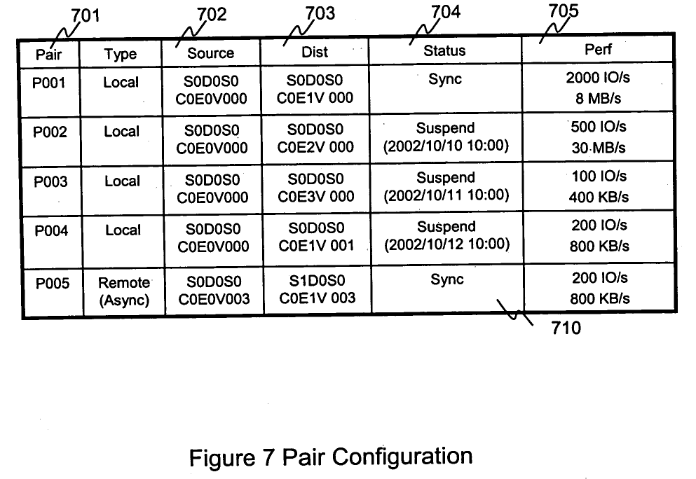

FIG. 7 illustrates a configuration of the replication pairs. The pair designation is given in column 701 with the source designation in column 702 and the destination in 703. The status, whether synchronized or in suspend mode is shown in column 704. Performance can be stored in column 705. Using the group to manage replication pairs helps reduce management overhead for the overall system operation.

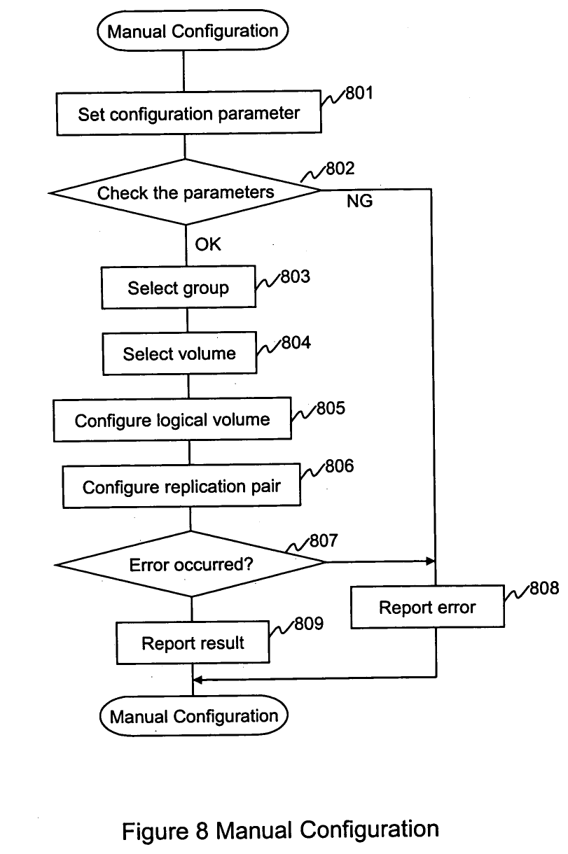

FIG. 8 is a flow chart illustrating manual operations for the system. To begin, the administrator provides parameters for replication volumes to the VPM server 106, as designated by step 801. The parameters in this example are levels of the failure boundary, addressing, performance, reliability, cost, and emulation of the volume. Then the VPM server 106 checks the parameters to determine if there are enough volumes to satisfy the needed requirements (step 802). If the server 106 finds some error in the parameters, or is short of volumes, then an error is reported to the administrator as shown by step 808. If the parameters are satisfactory, then the server 106 begins creating the replication pairs, as shown by steps 803 to 809. The VPM server 106 selects volume groups by using the VPM group table 204, as shown by step 803. The parameters indicate which failure boundary levels should be used. Usually the failure boundary level is indicated with some range, (for example from the error correction to the subsystem). The particular number of the group does not matter.

Next the VPM server 106 selects the volumes from the volume groups as shown by step 804. Here the server 106 uses addressing to indicate horizontal, vertical, or some other form, which is given at step 801 by the administrator. Configuration of the logical volume, emulation type, address from host view, and other information may also be provided. For FC SCSI environment the worldwide name (WWN) and the logical unit number (LUN) are the usual parameters for the address. The configuration of the replication pair indicates the source logical volume ant the destination logical volume.

If there is any error between steps 803 and step 808, than the error is reported out by the system and operation otherwise awaits instructions. This is shown by step 808. On the other hand, if the operations are completed successfully, then the final configuration result is reported out at step 809.

It should be noted that this invention does not limit itself to volume level only operations. The operations can be managed instead by a user of application group level. When an administrator presents the system group information and requires group replication, then the VPM server 106 creates the replication volumes for the group.

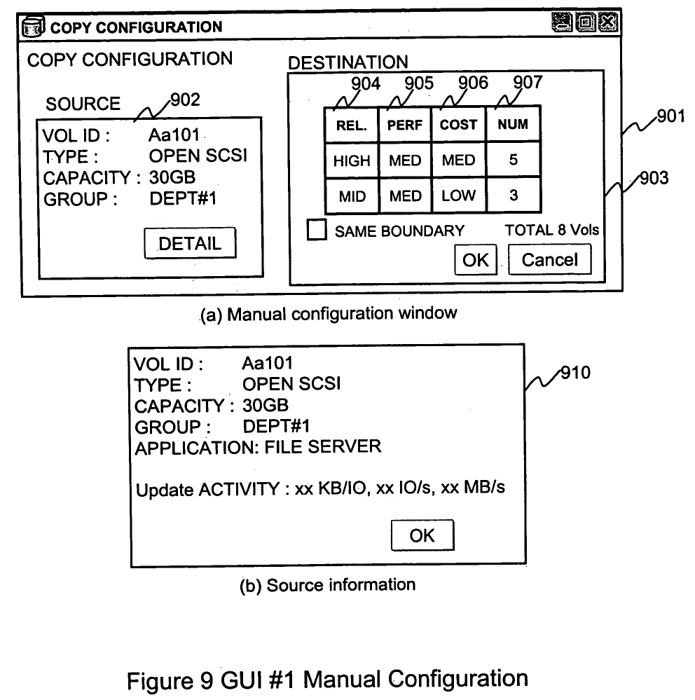

FIGS. 9 through 11 illustrate examples of a graphical user interface (GUI) to implement the procedures shown in FIG. 8. FIG. 9 illustrates an example of a configuration GUI. At first an administrator selects the source volume and begins the replication configuration procedure. This brings up a first window such as that shown in FIG. 9a. The window preferably contains two kinds of information. One type is information about the source volume, while the second are the parameters for replication volumes. The administrator then selects the parameters, for example reliability 904, performance 905, cost 906 and the number of replication volumes 907. These parameters will be given by the storage subsystem 102, however, it is generally easy to estimate them from the configuration information. If the administrator would like to use the same group as source volume then the box “same boundary” can be checked.

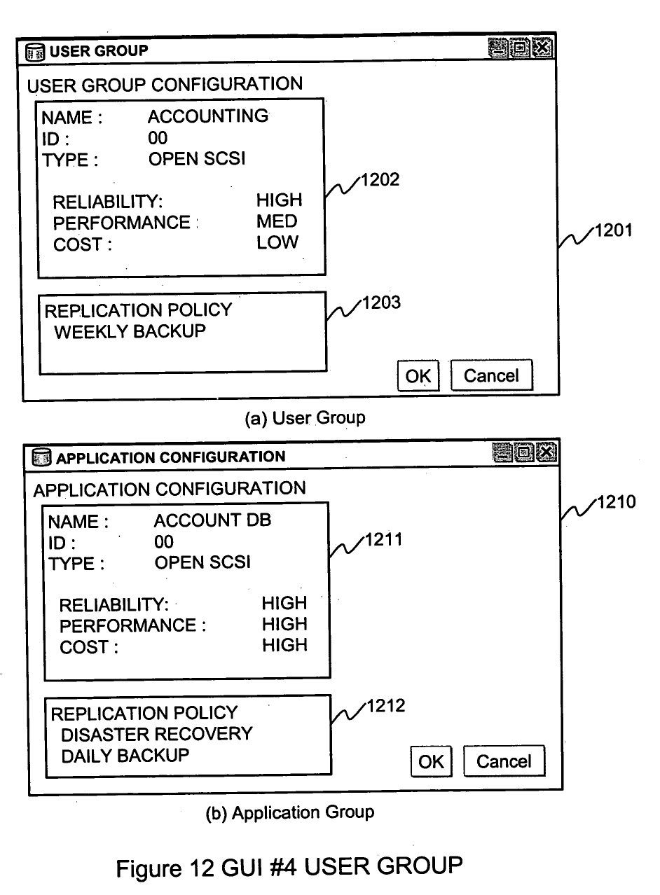

The source volume has basic information such as shown in FIG. 9b. The source information can be an identifier for the logical volume, its type, size, etc. Application and user information can also be employed. The user can be an individual or a group, for example a department. The use of the information is discussed below in conjunction with FIG. 12.

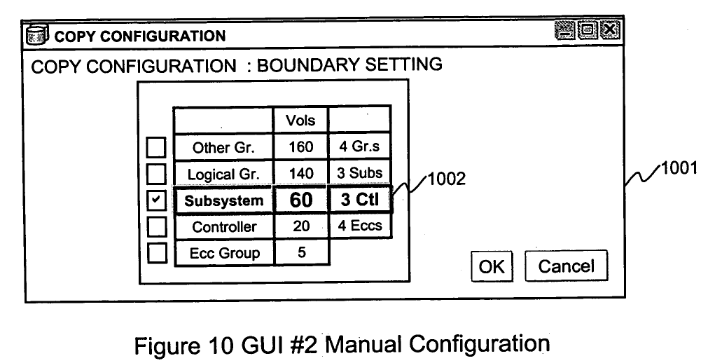

FIG. 10 illustrates an example of a GUI used to define a failure boundary. This example shows only one level for the failure boundary (in contrast to the earlier FIG. 3 which showed multiple levels). In the illustration the administrator is selected subsystem level. That provides an indication that there are three controllers in this subsystem which is the same system as the source logical volume. The table also indicates that there are 60 logical volumes in the subsystem. If desired, the VPM server 106 can provide the recommended boundary with the administrator having a capability of overriding that information.

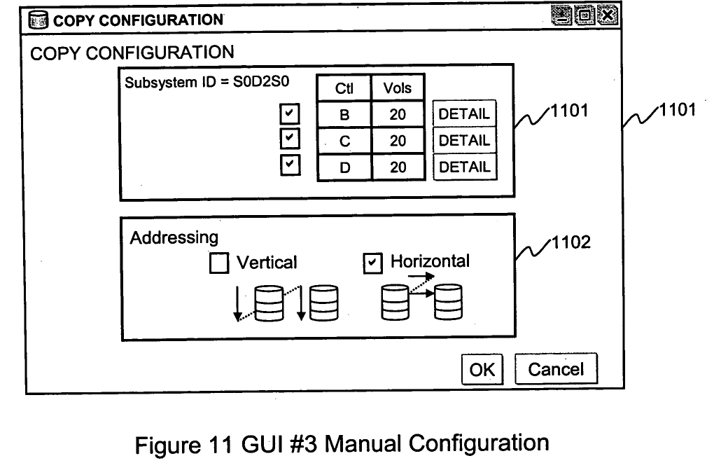

FIG. 11 is an example of the GUI 1101 for group selection and addressing 1102. The administrator has the capability of reviewing the details by clicking one of the detail buttons. As before, the VPM server 106 can indicate the recommended set of the configuration with the administrator being provided override capability. Following this window the VPM server 106 will select logical volumes from the selected group. And appropriate addressing may be chosen by the user.

FIG. 12 is another GUI to illustrate user group information 1201 and application information 1210. Here the source volume can have the same basic information 1202/1212 and the same replication policy 1203/1213. Both will have almost the same details. In this illustration “NAME” indicates the name of the user or application. “ID” is the identifier of the user application. “TYPE” is the type of source logical volume, while replication requirements are specified by “RELIABILITY,” “PERFORMANCE,” and “COST.” The replication policy 1203/1213 indicates the policy for the particular replication operation. Pre-definition by the policy administrator may eliminate the need to customize each logical volume. For some implementations, it may be easier to use a template for the policy. This will enable the template to contain information describing not only-the reliability, performance and cost, but also schedule, mixture of different types of volumes, etc.

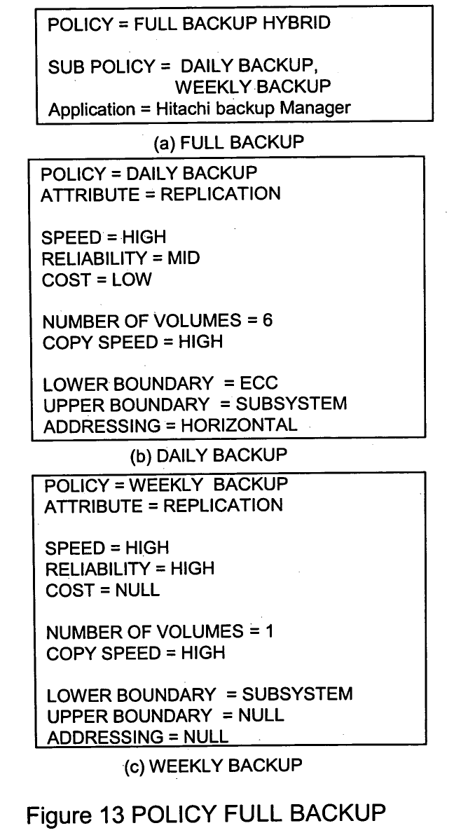

There are different policies that can be made for the daily backup operation. The first type, simply backing up daily to another storage volume uses conventional replication approaches. Another type, hybrid backup, uses a different approach and is shown in FIG. 13. The policy of the hybrid backup has sub-policies referred to as a daily backup policy and weekly backup policy. The daily backup policy can be implemented at high speed and low cost. To obtain the lower costs, the administrator may define remote operations to occur to low cost subsystems such as ATA disk drive based storage subsystems. These conditions can be changed to suit the particular customer environment. For example, in this case, six backups are taken from each day of the week from Monday to Saturday, and destination volumes will be within the same subsystem, but at different or across a different error correction group. To obtain reliable backups, preferably horizontal addressing is employed. A weekly backup can be taken on Sunday with high reliability. In this circumstance the failure boundary is defined across the subsystem.

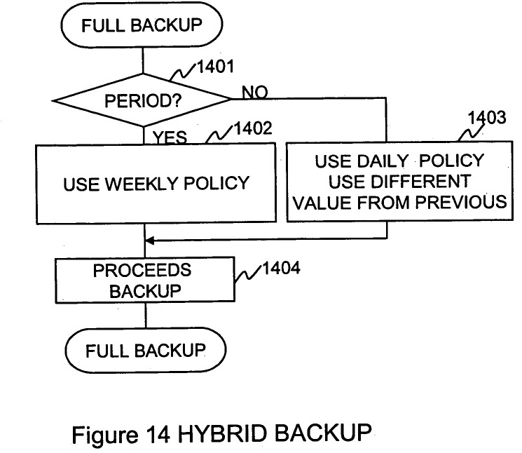

FIG. 14 is a flowchart diagram illustrating a schedule of the hybrid backup. The backup is taken at an indicated time, for example, midnight or later. In conjunction with this, the procedure shown in FIG. 14 is started. At first the VPM server checks the schedule (daily of weekly). If it is a daily backup then the server takes a backup with a daily backup policy. The replication volume will be selected as across the failure boundary. If horizontal addressing is employed, then server 106 only selects the next volume, 1401 or 1403. On the other hand if a weekly backup is to be taken then the backup was made with a daily backup policy 1401, 1402. In this case the VPM server 106 will take the backup to a selected volume 1404.

During the backup, if the replication pairs are synchronized, the backup can be taken by simply splitting the pair with a suspend command if the pair is not synchronized, then the pair will need to be resynchronized. Afterward the pair is split by the VPM server 106.

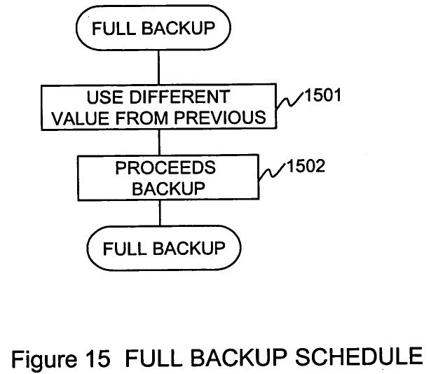

FIG. 15 illustrates a schedule for a daily backup. The VPM server 106 uses the same type of volume for each daily backup as shown by steps 1501 and 1502.

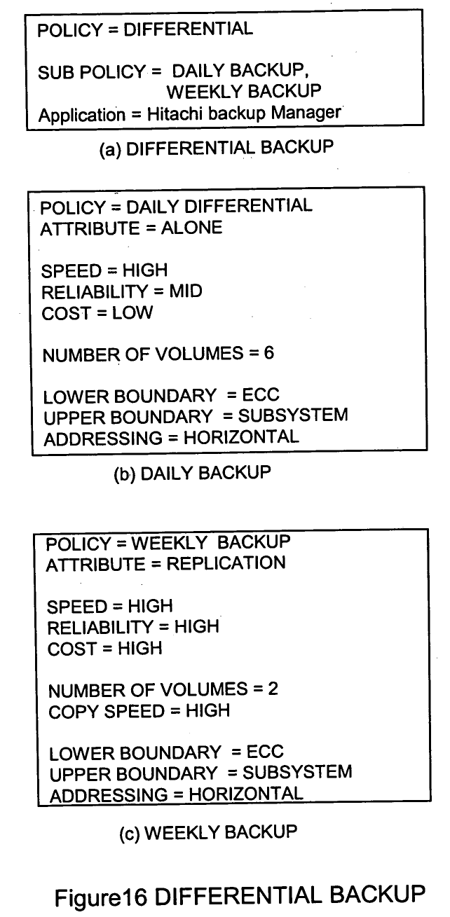

FIG. 16 is a diagram illustrating differential backup. The differential backup uses two kinds of volumes. One is a full backup volume which is replicated over a long period, for example once a week. This full backup will be the same as the source volume. Based on the source volume, the differential backups make small differential backups every so often, for example daily. Usually the differential backup makes differential data based on the full backup. The differential data does not need the same types of volumes as the source volume, so, for example, lower cost or slower hard disk drives may be employed.

Often the backup software will make a full backup and a differential backup. In this case the stored subsystem has the capability of taking the full backup. Thus, some backup software can collaborate with the storage backup capability. FIG. 16 illustrates a policy for the differential backup. The policy A consists of two policies. One is a daily backup B, the other is the weekly backup C. For the daily backup B, the VPM server 106 does need to prepare a volume. The same volume as the source volume is necessary to prepare a high reliability volume, and thus, the policy requires middle levels of reliability. In addition, the volume is not related to the replication. A differential backup can be recovered without previous differential backup by using the full backup.

An incremental backup operation uses two kinds of volumes. One is a full backup volume which is replicated over the long period mentioned above. This full backup will be the same as the source volume. Based on this volume, incremental backups are made on a short period, for example daily. Use of the incremental backup makes a differential data based on previous differential backups or full backups available. The incremental data does not need to use the same type of volumes as the storage volumes. As mentioned, usually the backup software will make a full backup and an incremental backup. In such cases the software often has the capability of collaborating with the storage backup capability.

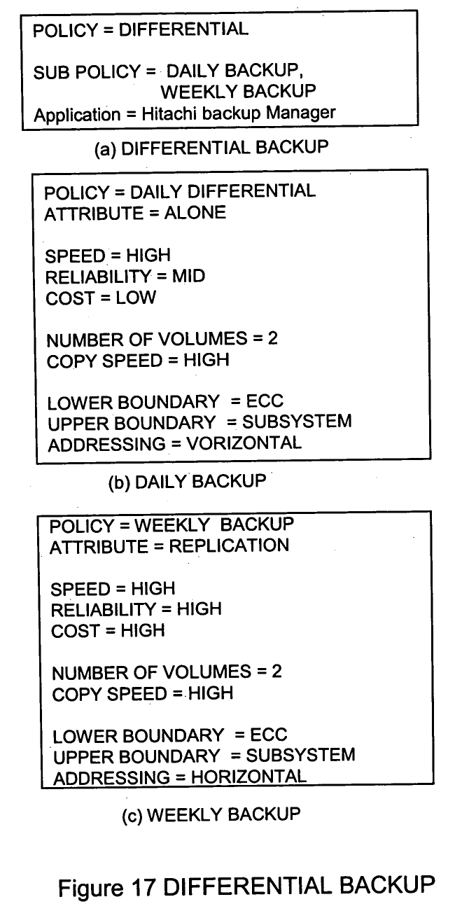

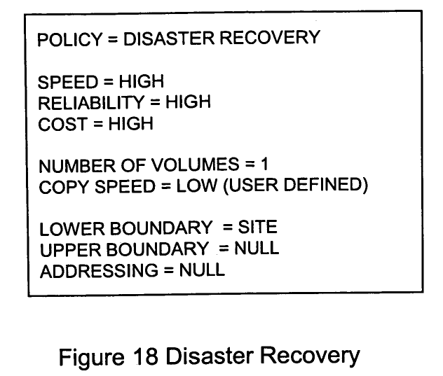

FIG. 17 is a diagram illustrating a policy for an incremental backup. The policy A consists of two policies. One is a daily backup B and the other is the weekly backup C. For the daily backup B, the VPM server 106 does not need to prepare the same volume as the source volume. It is not necessary to have a high reliability volume, instead a middle level reliability may suffice.

The preceding has been a description of preferred embodiments of the method and apparatus for copying and backup and storage systems in which failure boundaries are used to improve reliability. Although specific configurations and implementing technology have been described, it should be understood that the scope of the invention is defined by the appended claims.

1. A method of controlling a storage system having primary storage volumes and replication storage volumes which replication storage volumes improve reliability of the storage system, the method comprising:
determining a boundary of a potential failure of the primary storage volumes and the replication storage volumes; and
using the determined boundary to assign replication storage volumes to assure that at least some of the replication storage volumes are outside the failure boundary.

2. A method as in claim 1 wherein the potential failure boundary is determined by software managing the storage system.

3. A method as in claim 2 wherein a logical address of locations in the storage system is used to determine the failure boundary.

4. A method as in claim 1 wherein there are a plurality of failure boundaries and each is determined by software managing the storage system.

5. A method as in claim 4 wherein information regarding the failure boundaries is stored in a server.

6. A method as in claim 5 wherein the information regarding the failure boundaries is stored as a table in the server.

7. A method as in claim 5 wherein information regarding the failure boundaries also includes information about reliability of the primary storage volumes and the replication storage volumes.

8. A method as in claim 1 wherein the boundary of the potential failure is used to assign storage volumes as replication storage volumes for a particular operation of the storage system.

9. A method as in claim 8 wherein the failure boundary information includes error correction group and controller group information for each of the primary storage volumes and the replication storage volumes.

10. A storage system comprising:
a set of primary storage volumes;
a set of replication storage volumes for improving reliability of the storage system;
a memory for storing information regarding at least one boundary of a potential failure of the primary storage volumes and the replication storage volumes; and
a controller coupled to the memory for assigning replication storage volumes to assure that at least some of the replication storage volumes are outside the failure boundary.

11. A storage system as in claim 10 wherein the memory storing information regarding the at least one boundary of a potential failure is in a server and the server is used to manage the storage system.

12. A storage system as in claim 11 wherein the information regarding the failure boundaries is stored as a table.

13. A storage system as in claim 11 wherein information regarding the failure boundaries also includes information about reliability of the primary and replication storage volumes.

14. A storage system as in claim 11 wherein information regarding the failure boundaries also includes information about performance of the primary and replication storage volumes.
